(19) United States
(12) Patent Application Publication
(10) Pub. No.: US 2021/0230898 A1
(43) Pub. Date: Jul. 29, 2021

(54) IMPROVED INTERNMENT SYSTEM

(71) Applicant: Ahmad KAMALEDINE, Greenacre (AU)

(72) Inventor: Ahmad KAMALEDINE, Greenacre (AU)

(21) Appl. No.: 17/051,244

(22) PCT Filed: Mar. 22, 2019
(86) PCT No.: PCT/AU2019/050255

§ 371 Date: Oct. 28, 2020

(51) Int. Cl. E04H 13/00

(52) U.S. Cl. CPC E04H 13/00

(57) ABSTRACT

A system for renewable interment and improved body decomposition, comprising: a vault assembly comprising at least one reusable vault mounted on a raft; the at least one reusable vault comprising a respective removable access wall wherein the removable access wall is selectively removable from the vault to allow access for reuse; wherein the raft comprises at least one footing structure adapted to underlie the at least one reusable vault such that the ground on which the footing structure rests is adapted to function as the floor of the reusable vault; and a porous granular material adapted to at least partially bury the at least one footing structure and at least partially surround the at least one reusable vault to direct oxygen-carrying fluid through and out of the vault assembly such that the growth of decomposition bacteria is supportable within the at least one reusable vault.

### TECHNICAL FIELD

The present invention relates to an improved interment system. More particularly, the present invention is directed towards an interment system which is renewable, sustainable and/or affordable and improves body decomposition.

### BACKGROUND

There are two common methods of care used in relation to deceased persons; burials and cremation. However, cremation services may not be suitable for a particular religion, or may be undesired, but due to shortages in grave plots availability and the high cost of burials customers are opting for cremation as alternative method. As such, traditional in ground burials are still a common method for laying to rest a deceased person., and in fact this may be the only methods for specific religions.

There are also two common type of burials methods; in a coffin and out of coffin, in-coffin type of burial is a deceased person lay to rest in a coffin, in bottom of the trench and soil is backfilled. In contrast, out of coffin requires that the deceased person be wrapped in cloth (shroud) and lay to rest in pre-built chamber (tomb). Irrespective of the type of burial performed, cemetery land is consumed and the cost liability of long term maintenance is incurred.

However, with growing populations and larger numbers of deceased persons annually, the space for which to bury these persons is increasingly becoming more and more scarce and therefore more expensive. Further, as population increases within popular cities and suburban areas through high density living, no expansion planning to cemeteries to equal population growth, this has put a strain on old and existing cemeteries to keep up with demand and in fact, cemeteries with high populated cities and suburban areas are closed or facing closure.

It is common practice by cemetery operators in some countries to revive and prolong the life of cemeteries by re-using grave plots. This practice poses many health, ethical and environmental challenges, due to partially decomposed human bodies. This is despite the fact that the buried human bodies are decades old. To re-use a grave plot, partially decomposed bodies are exhumed and buried deeper to make room for new human remains. This practice is likely to increase soil and groundwater pollution as referred to in the 1998 World Health Organisation report EURICP/EHNA 01 04 01(A). Human body remains can take up to 100 years to fully decompose, pending type of soil, porosity, oxygen, temperature and coffin type. The practice of re-using grave plots is deemed to be unsustainable in most conditions and can often exacerbate the problem.

The most common form of burial is a trench burial system in which a vertical trench is dug and a casket can be placed in the bottom of the trench. Another, less used, form of burial is an Al-Lahad type burial, in which a trench is dug in an L shape which comprises a vertical trench and a portion of the wall is undercut allowing for placement in the undercut portion of the trench.

Currently, some countries are wrapping bodies with plastics and using plastic for the inner lining of coffins or other similar materials to improve hygiene when handling the body or being near to the body up until burial. This has also been found to drastically decrease the decomposition times after burial.

Another system currently proposed to deal with the increasing deceased and the reduced cemetery spacing is to construct high-rise structures which can accommodate a plurality of caskets. In this way these structures are more similar to above-group crypts, however these structures are incredibly expensive and again may not be desired by particular cultures or religion and neither satisfies tradition “dust to dust” beliefs. Further, the time required to construct these above ground structures is significant and may not effectively deal with growing numbers of deceased, and therefore not a sustainable permanent solution.

There are also systems which allow for stacking caskets to be mounted on each other to form a stacked burial arrangement. Such a stacked burial arrangement is discussed in U.S. Pat. No. 3,230,674 which discloses a combination burial liner and vault and method of burial. This particular device does not resolve the problems faced with common systems, as the device does not promote decomposition of a body, but rather would increase the time for decomposition.

As such, there is a need to resolve the consumption of cemetery space, and also improve current systems for burials. There may also be a need for a more effective interment system which is more sustainable relative to known systems.

Any discussion of the prior art throughout the specification should in no way be considered as an admission that such prior art is widely known or forms part of common general knowledge in the field.

### SUMMARY

### Problems to be Solved

It may be advantageous to provide for an improve interment system which allows for faster body decomposition.

It may be advantageous to provide for a burial system which may allow for re-use of a plot after burial.

It may be advantageous to provide for a burial system which reduces potential health risks.

It may be advantageous to provide for a system which assists with decomposition of a body which has been buried.

It may be advantageous to provide for a system which reduces the need for expanding cemeteries.

It may be advantageous to provide for a sustainable burial system which may reduce the use of resources.

It may be advantageous to provide an affordable burial system in accordant with different cultures, tradition or beliefs.

It may be advantageous to provide one resting place for family present and future members.

It may be advantageous to minimize or reduce cemeteries up-keep and ongoing maintenance cost.

It may be advantageous to minimize and eliminate water and soil contamination.

It may be advantageous to eliminate the need to dispose contaminated soils left over from digging a grave plot.

It may be advantageous for families to know that their loved one is NOT submerged in water and body partially preserved.

It is an object of the present invention to overcome or ameliorate at least one of the disadvantages of the prior art, or to provide a useful alternative.

### Means for Solving the Problem

In a first aspect there may be provided a system for renewable interment and improved body decomposition, the system comprising a vault assembly comprising at least one reusable vault mounted on a raft; the at least one reusable vault comprising a respective removable access wall, wherein the removable access wall is selectively removable from the vault to allow access for reuse; wherein the raft comprises at least one footing structure adapted to underlie the at least one reusable vault such that the ground on which the footing structure rests is adapted to function as the floor of the reusable vault; and a porous granular material adapted to at least partially bury the at least one footing structure and at least partially surround the at least one reusable vault to direct oxygen- carrying fluid through and out of the vault assembly such that the growth of decomposition bacteria is supportable within the at least one reusable vault.

Preferably, the fluid drains through the porous granular material towards the bottom of the vault. In a preferred embodiment, the system comprises a plurality of reusable vaults. The vaults of the vault assembly preferably comprise two side walls, a rear wall and a ceiling which are integrally formed and define a vault receptacle, wherein the vaults are constructed without a floor. The vault and raft may be wholly buried by the porous granular material. In a preferred embodiment, the porous granular material is an engineering soil fill.

The removable access wall of the vault may comprise a plurality of panels and at least one access means. The footing structures can be retained in a predetermined spacing by a spacer, further comprising retaining flanges in which the footing structures are mounted. The ceiling of the reusable vault may be tapered towards the rear wall to direct liquids away from the removable wall. A lip can be provided in the vault to mount the removable access wall. In a preferred embodiment, the raft elevates the vault above a natural ground level. The oxygen-carrying fluid can be water, such as rain water.

In another aspect, there may be provided a system for renewable interment and improved body decomposition, the system comprising; a vault assembly comprising at least one reusable vault mounted on a raft, the at least one reusable vault comprising two side walls and a ceiling defining a receptacle; the reusable vault further comprising at least one removable access wall to allow access to the receptacle for reuse; wherein the walls are supported on at least one footing of the raft, and wherein the at least one footing is retained in a predetermined position by at least one spacer; and wherein a porous granular material is adapted to at least partially bury the at least one footing structure and at least partially surround the at least one reusable vault to direct oxygen-carrying fluid through and out of the vault assembly such that the growth of decomposition bacteria is supportable within the reusable vault.

Preferably, the system comprises a plurality of reusable vaults. The spacers may be perpendicular to the footings; and the vault may further comprise a rear wall which opposes the removable access wall. The removable wall may comprise a plurality of panels.

In a further aspect, there may be provided a method for constructing a renewable interment and improved body decomposition system, the method comprising; mounting a footing structure on a ground surface; fixing at least one reusable vault to the footing structure to form a vault assembly in which a bottom of the reusable vaults is exposed to the raft; burying at least a portion of the vault assembly with a porous granulated engineering soil so as to at least at least partially bury the at least one footing structure and at least partially surround the at least one reusable vault to direct oxygen-carrying fluid through and out of the vault assembly such that the growth of decomposition bacteria is supportable within the reusable vault; and installing a topsoil section over the engineering soil relatively above the vault assembly.

The footing is preferably mounted on a geotextile on the ground surface to minimize loss or integration of the porous granulated engineering soil into natural ground. A plurality of vault assemblies are preferably constructed in parallel in which respective topsoil sections are installed relatively above respective vault assemblies of the plurality of vault assemblies, and at least one pathways is constructed between the topsoil sections. The pathways may be removable such that a trench can be excavated to install a resident into the vault assemblies.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 illustrates an isometric view of an embodiment of a vault for an interment system which is adapted to house a casket or body;

FIG. 2 illustrates an exploded view of FIG. 1 in which the access panels of the vault are removed;

FIG. 3A illustrates an isometric view of an embodiment of an interment system footing and drainage system for excess water runoff;

FIG. 3B illustrates a side of the embodiment of FIG. 3A;

FIG. 4 illustrates an isometric view of an embodiment of a drainage system based on natural landscaping for use with the interment system;

FIG. 5 illustrates an isometric view of an embodiment of another drainage system based on natural landscaping for use with the interment system;

FIG. 6A illustrates an embodiment of an interment system installed above a natural ground level;

FIG. 6B illustrates an embodiment which shows rain water flow and oxygen supply to inner vaults;

FIG. 6C illustrates an embodiment of a system and monuments with soil stability support;

FIG. 6D illustrates an embodiment of soil retention plantation means for water absorbent and sand stability support;

FIG. 7 is a flowchart an embodiment for installation of the system;

FIG. 8 illustrates an isometric view of an embodiment of the system in which a trench has been excavated to access a vault;

FIG. 9 illustrates a bottom view of an embodiment of a vault with a plurality of access panels; and

FIG. 10 illustrates an example of a shoring cage used when excavating, which may be used in a trench such as that exemplified in FIG. 8.

### DESCRIPTION OF THE INVENTION

Preferred embodiments of the invention will now be described with reference to the accompanying drawings and non-limiting examples.

### LIST OF FEATURES

10 System
15 Trench
16 Plants
20 Vault assemblies
25 Gap
30 Pathway
40 Monuments
45 Piers
50 Engineering soil
60 Geotextile
70 Topsoil
90 Natural ground
100 Vault
101 Vault room
102 Walls
104 Ceiling
106 Open side
108 Removable wall
110 Panels
112 Access means
114 Lip
116 Mating arrangement
120 Raft
122 Footing
124 Spacer
126 Retaining flange
128 Supports
200 Method for installation of system
202 Step 1 of method
204 Step 2 of method
206 Step 3 of method
208 Step 4 of method
210 Step 5 of method
212 Step 6 of method
214 Step 7of method
214 Step 8 of method

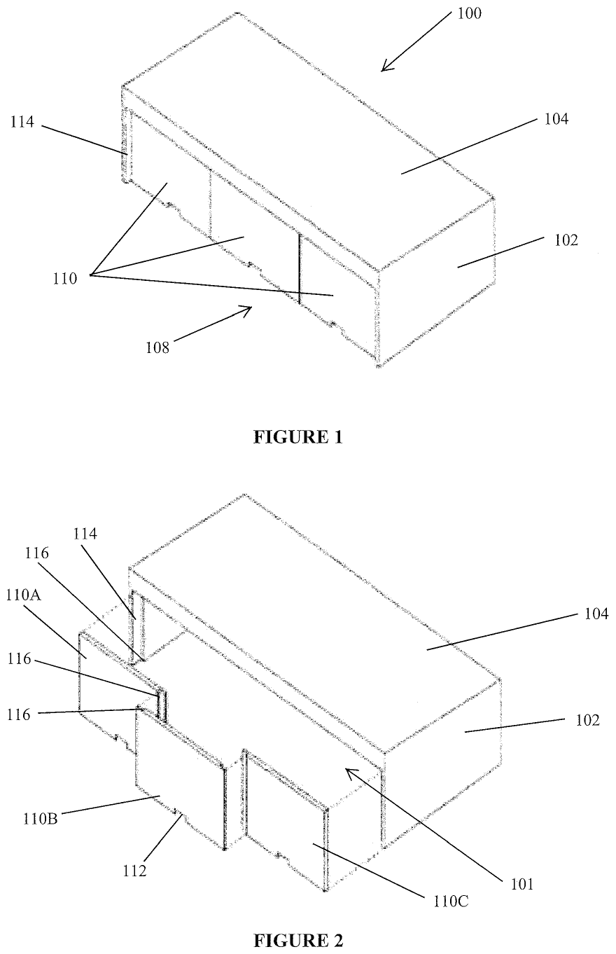

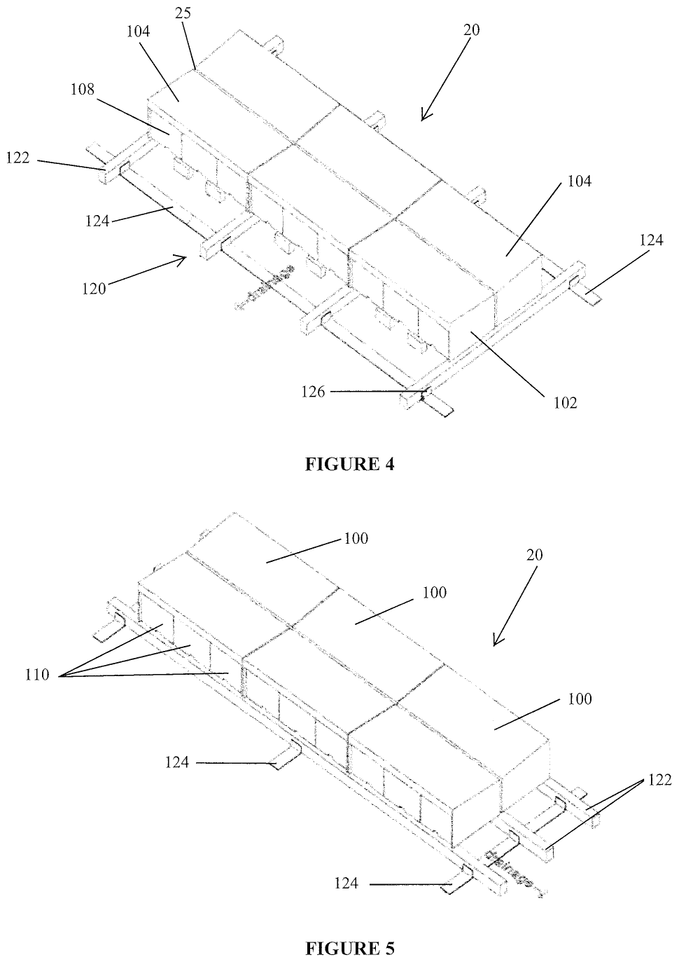

Referring to FIG. 1 there is illustrated an embodiment of a vault 100 for an interment system 10. A system 10 can be formed from a plurality of vaults 100 which form receptacles for caskets or wrapped bodies. Preferably, the plurality of vaults 100 form vault assemblies 20 in combination with a raft 120 (see FIGS. 4 to 6). The vaults 100 may be formed from concrete, stone, granite, composite, galvanised steel, coated steel, c01 Tosion resistant metal, polymers, or any other material which can reside in a buried and/or partially submerged state for a period of at least 3 years. More preferably, the vaults are designed to remain in a fit for use state while buried and/or partially submerged for between 5 years to 100 years, or 5 years to 80 years, or 5 years to 50 years, or 5 years to 20 years, for example. Each vault 100 of the system 10 may be formed separately, such that vaults 100 can be replaced if a vault 100 fails during use, while allowing adjacent vaults 100 to remain unaffected if they are in a structurally sound condition.

Each vault 100 may comprise at least two walls 102 and a ceiling 104. The two walls102 are connected to the ceiling, or integrally formed therewith. Preferably, the vault comprises three walls, with two being side walls 102 and the third being a rear wall 102, with one side of the vault 100 defining an open side 106. The walls 102 and ceiling may be formed from the same material, or may be formed from different materials as the ceiling 104 of the vault will be designed to carry a compressional load across the length of the ceiling 104, while the vault walls 102 will be used to suppoli the ceiling 104. A removable wall 108 can be installed in the open side 106 to allow for selective sealing of the vault 100, and can be removed to allow access to the interior of the vault 100 when desired.

The removable wall 108, as shown in FIGS. 1 and 2, is formed from a series of panels 110 which can be installed side by side to form a contiguous removable wall 108. Optionally, the panels 110 (110A, 110B, 110C) may be fitted with seals or mating arrangements 116 to allow for a superior fit in the vault open side 106 to ensure that the panels 110 experience little movement within the system 10 when in use. Each panel 110 may be fitted with a handle 112 or other access means 112 to assist with removal of the panels 110. The panels 110 may be fitted within a lip 114 of the vault 100 which may also comprise mounting means to assist with mounting the panels 110 to the open side 106. A mating arrangement 116 may be formed at the sides of each panel 110 and adapted to prevent or reduce ingress of fluids and engineering soils into the receptacle of the vault 100 during use. In this way a constant supply of oxygen can be provided to inner vault to accelerate decomposition, relative to known methods.

The bottom of the walls of the vault 100 can be suppolied by a raft 120. Preferably, the vault does not include a floor, however, the backfill of sand partially covering the rafts may be used as the vault floor, such that moisture or liquid entering into the vault 100 can saturate sand in the bottom of vault and excess water can drain through to the raft 120 supporting the vault 100. The raft 120 acts as a support structure for the vault 100 and forms a gap between the underside of the vault 100 and natural ground 90, bedrock or other relative ground level. The raft 120 can be secured to the natural ground 90 by spikes, pins, anchors, bolts, or any other desired securing means (not shown). In another embodiment, the vault 100 raft “floats” on a geotextile 60 which can be used to reduce movement of vault assemblies 20 and also reduce engineering soil losses.

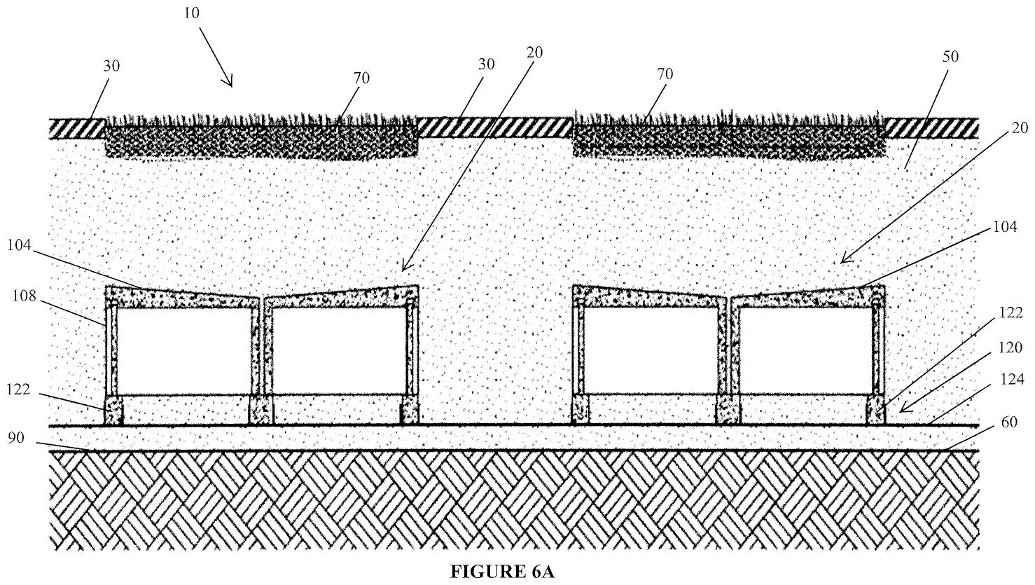

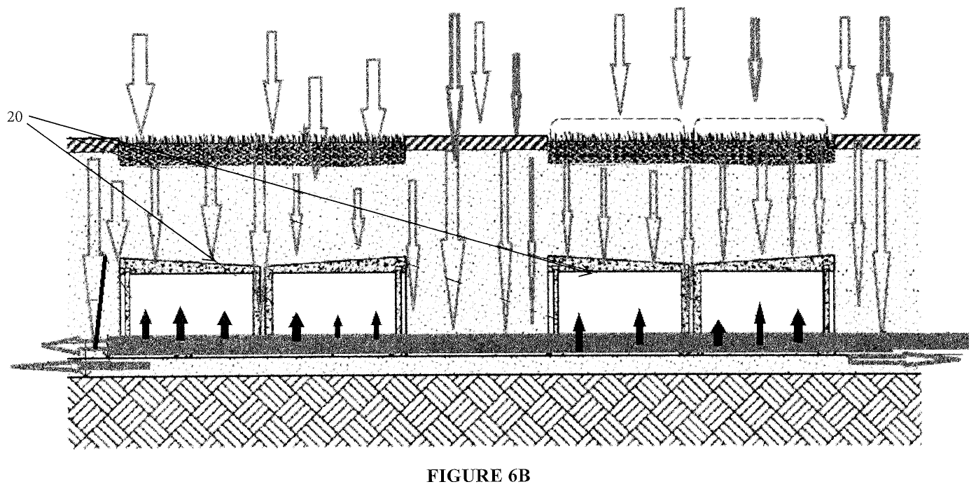

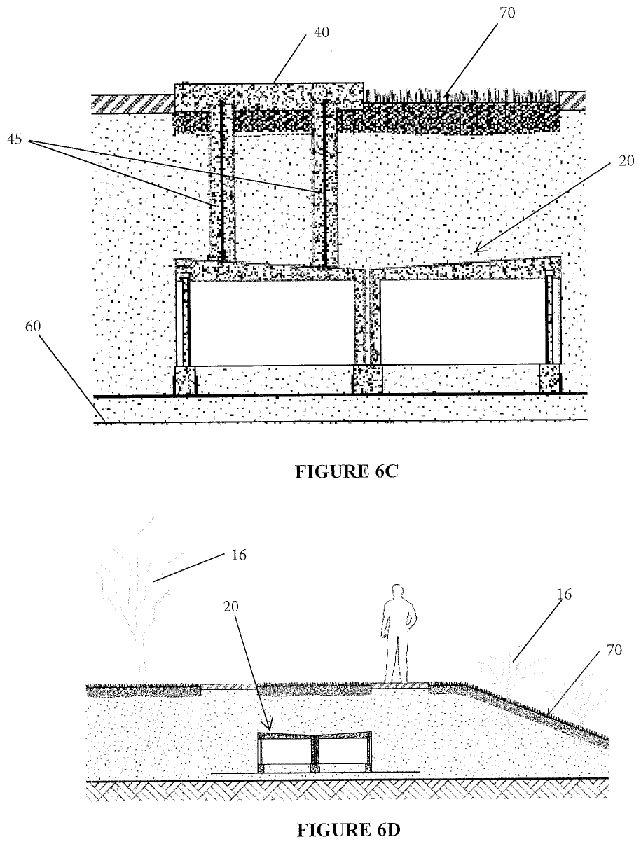

The ceiling 104 of the vault 100 comprises a sloped upper surface which is adapted to direct liquids over the ceiling and preferably away from the open side 106 (see FIG. 6A for example). The lower ceiling portion forms part of the receptacle and is preferably parallel with the raft structure footings 122. The sloped upper surface of the ceiling may also have cannels formed therein or a textile to more effectively channel liquids and direct liquids. The ceiling may allow fluids to be more readily diverted from above the vault 100 and down towards the raft 120 of the vault assembly 20. Diverting fluids to the raft 120 will allow fluids to move along the natural ground 90 and out of the system 10 which is not known in conventional interment systems. In this way the vaults 100 can be kept in a moist and/or oxygenated state during rain fall, which may allow for decomposition of residents without disruption.

The walls 102 and ceiling 104 are preferably formed with a reinforcing structure, such as rebar or another common steel structure, which assists with maintaining the integrity of the vault, particularly for regions of the vault which experience tensile forces which may reduce the effectiveness of concrete structures or structures formed from materials with a low ultimate tensile strength.

The walls 102 of the vault 100 are preferably pre-stressed concrete sections which are manufactured offsite before installation in the system 10. Optionally, post-stressed concrete may be used instead.

FIG. 2 illustrates the exploded embodiment of FIG. 1, in which the removable wall 108 formed from panels 110 have been removed from the vault 100. As can be seen, the mating arrangement 116 of the vault is such that the middle panel 110B is to be removed before the side panels 110A, 110C can be removed. A flange at the ends of the middle panel 110B mates with a respective and complimentary flange of the side panels 110A and 110B. The panels can be received in the lip 114 which is defines by the side walls 102, and optionally the ceiling 104. It will be appreciated that other panel mating arrangements 116 can also be used to form the removable wall 108. In one embodiment, the removable wall is a single panel which can be installed and removed as desired. In another embodiment, the removable wall 108 is a frangible or sacrificial wall which can be destroyed to access a receptacle when desired.

The structure supporting the vault 100 is a raft 120, which comprises a footing structure 122 and a plurality of spacers 124 which retain the footings in a location relative to the vaults 100. The raft spacer 124 may be directly mounted onto a natural ground level 90 or onto a geotextile disposed on a natural ground level 90. The raft spacer comprises a plurality of retaining flanges 126 which are adapted to seat the footings 122 which support the vault 100.

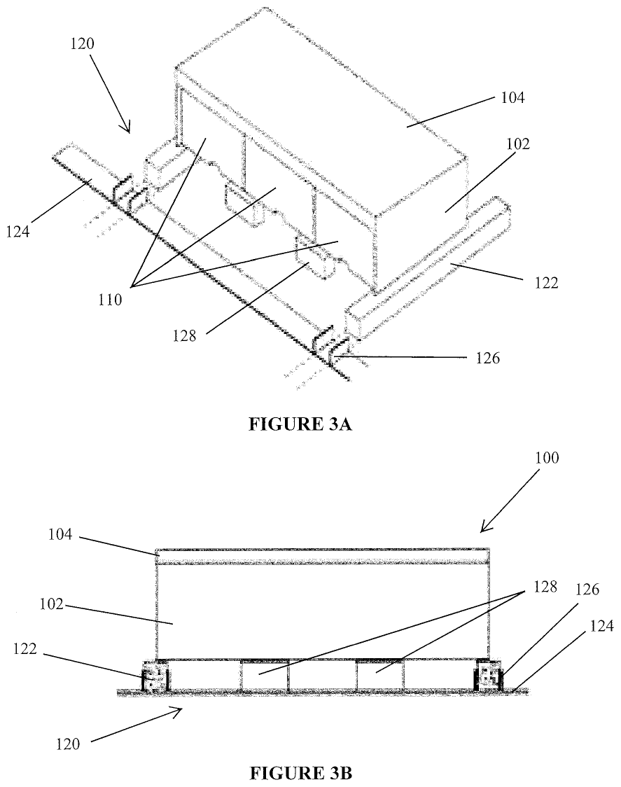

The walls 102 of the vaults 100 can be directly mounted onto the footings 122 as shown in FIG. 3A and 3B, and the footings can be retained by the spacers 124. Additional supports 128 can be provided to support the vault 100 if footings 122 are not provided. Reducing the number of footings may assist with improving liquid flows and drainage of the system 10. Footings 122 may be fixed to spacers 124, with the configuration of the raft being such that the footings 122 run perpendicular to the spacers 124. The footings can be constructed of metals, metal alloys, concretes, polymers or any other desired materials. Similarly, the spacers may be constructed of metals, metal alloys, concretes, polymers or any other desired materials, but more preferably a metal or metal alloy is used. The spacers 124 of the raft 120 can be galvanised or to be protected from liquid corrosion.

Referring to FIGS. 4 and 5, there are shown embodiments of a vault assembly 20 with different drainage structures formed by the raft 120. In FIG. 4, the direction of flow is perpendicular to the plane of the removable wall 108. The footings 122 are disposed in a direction which is substantially parallel to the flow of liquids and may assist with directing said liquids.

FIG. 5 represents an embodiment in which the footings are parallel to the plane of the removable wall 108 and also parallel to the flow of liquids. In this embodiment additional supports 128 are not required as the footings extend along the rear wall 102 and the removable wall 108. Preferably, the raft 120 has a larger footprint than that of the vaults and acts similar to a pad footing. Optionally, weep holes or other fluid apertures (not shown) may be disposed in the footings 122 of the raft 120.

A sectional view of an embodiment of the system 10 with a plurality of vault assemblies 20 is shown in FIG. 6A. Each of the vault assemblies 20 are supported on respective rafts 120. The rafts 120 are preferably supported by natural ground 90, bedrock, or material which is not backfill. Liquids entering into the system 10 may be allowed to flow to the natural ground level 90 and along said ground level out of the system by passing from the topsoil 70 and pathways 30 through the engineering soil 50, as can be seen in the embodiment of FIG. 6B. In this way more efficient drainage can be provided to the system 10. Engineering fill is preferably provided above the vault assemblies 20 and in the access channels (between vault assemblies). Topsoil can be provided above vault assemblies to allow for installation of lawn and monuments or other memorial devices. Monuments40 may also be used to record information about the burial and dates.

Monuments 40 and other memorial structures can be supported by piers 45, which may be drilled holes filled with concrete into the sand and down to the top of vault, as seen in the example of FIG. 6C, these piers 45 will contribute to sand stabilise. The piers 45 may be of any predetermined construction and may also assist with maintaining the structural integrity of the vault in the event of concrete cancer or other vault failures. A variety of trees and plants with the ability to thrive on sand can be planted to further stabilise the system, trees and plants will also play a significant role as an absorbent to water within the system. Further, the root structure of these plants 16 will assist with reduction of slope soils and soils within the system from migrating due to environmental factors. An example of this retention system can be seen in FIG. 6D. Preferably, if sands are used as engineering soils, the sands can be treated with a binder or other product to increase the adhesion between the sand particles such that the sand stiffness or adhesiveness can be improved. In this way vaults may be supported by the sands in the event of failures after prolonged use.

Plots or monuments 40 may be positioned to identify a burial location. Plots or monuments 40 may be positioned on topsoil sections of the system 10. The topsoil sections may be imported fill suitable for growing organic matter. When vaults are not being used, the topsoil may be used for growing organic matter, such as grass, trees or flowers, for example. Between topsoil sections a pathway 30 may be constructed. The pathways may cap a section which can be excavated to form a trench to access the vaults 100 of the system 10. The pathways 30 may be constructed from paving materials, ceramics, concrete or other removable structures such that the pathways can be removed to form a trench.

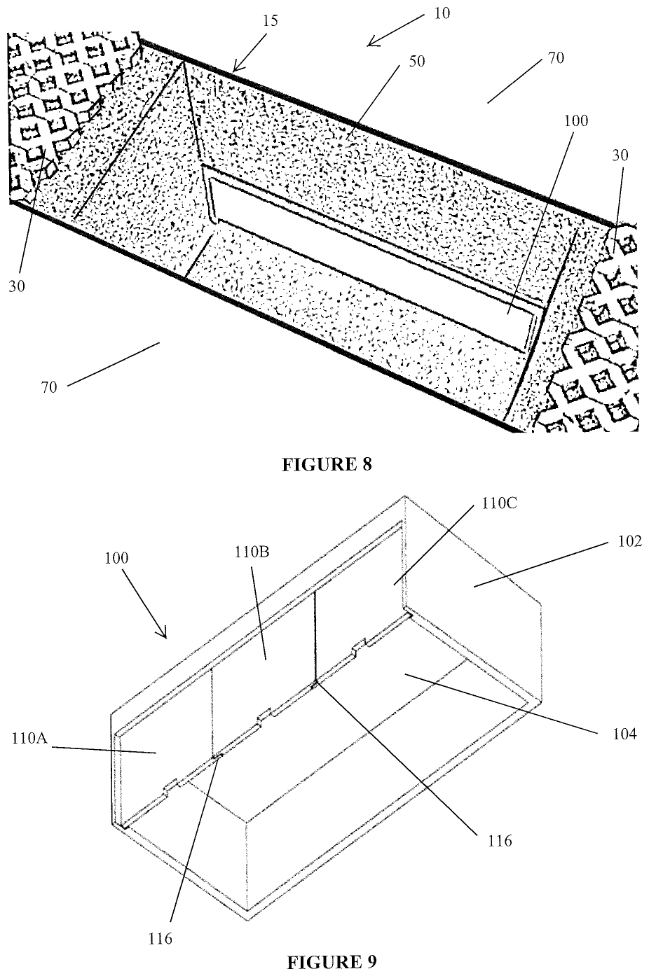

Optionally, the pathways 30 may be formed from a mesh which can be partially embedded within the engineering soil backfilling the system 10. The mesh may be formed from a durable and flexible material, such as PVC, PP, PE, aramid composites, rubbers or any other predetermined material. The mesh may have a thickness of between 10mm to 150mm, depending on the structure. An embodiment of the mesh is illustrated in FIG. 8, in which a portion of the mesh has been removed to allow a trench 15 to be constructed. Portions of the pathway may be removable and may align with a vault 100 of the system such that removing predetelmined a portion of the mesh or pathway will indicate the location of a removable wall of the vault 100. A shoring cage 300 is illustrated in FIG. 10, in which the cage comprises four veliical walls used to retain cut batters of excavated walls. The cage 300 comprises corner posts 310 which can be hammered into the ground at a desired location. After the corner posts have been hammered into position, the shoring panels 320 can be hammered into position between respective corner posts 310. Once the panels have been hammered to the desired depth, the engineering soil can be excavated. After excavation, one of the walls 330 formed by the shoring panels can be raised to allow for access into a vault. The panels 320 can be locked into position during use.

While PVC may be used for paving access channels (which can be excavated to form a trench 15) for the vaults 100, other materials may be used which are more resistant to UV radiation. For example, ceramics or composite materials may be used which are resistant to weather conditions, and also have suitable compressional propeliies for heavy machinery to be mounted on.

The vaults 100 are positioned such that the open sides 106 of the vaults 100 are accessible when a trench 15 is dug between vault assemblies 20, or when the access channels are excavated. Trenches 15 will typically be dug in the region below the walkways of the system 10. It is preferred that any cuts are shored or retained as trenches 15 are dug. Optionally, an anchor location may be provided on the ceiling 104 of the vaults 100 to which retaining means can be mounted while a trench 15 is open.

As discussed above, the ceilings 104 of the vaults 100 preferably comprise a sloping upper surface to direct liquids permeating through the engineering soil to the vaults 100. The sloping upper surface of the ceiling 104 preferably slopes away from the open side 106 and down towards the rear of the vault 100 towards gap 25. The vault assemblies 20 of the embodiment have a rear wall, which opposes the open side 106. A pair of vaults 100 may be disposed in a vault assembly 20 such that the rear walls 102 are adjacent (see FIGS. 4 and 5). Optionally, the same footing 122 may be used to support the adjacent rear walls 102 as is illustrated in FIG. 6. In this configuration, the sloping surfaces of the ceilings 104 direct liquids to gap 25 between the vaults 100 and the liquids can then flow down to the raft 120 supporting the vault 100. Liquids may drain more efficiently compared to known systems 10 and improve oxygen flow into the vaults in a relatively shorter amount of time.

The drainage path of the liquids is preferably in the direction of natural water runoff, which will typically be parallel to the slope of the natural ground or underlying bedrock as can be seeing in FIG. 6B. In this way, the footings 122 are not impeding the flow of liquids and inadvertently retaining fluids below the vaults 100. The footings 122 preferably raise a vault between 50mm to 400mm from the underside of the spacer 124 to allow for the free movement of fluids there-under.

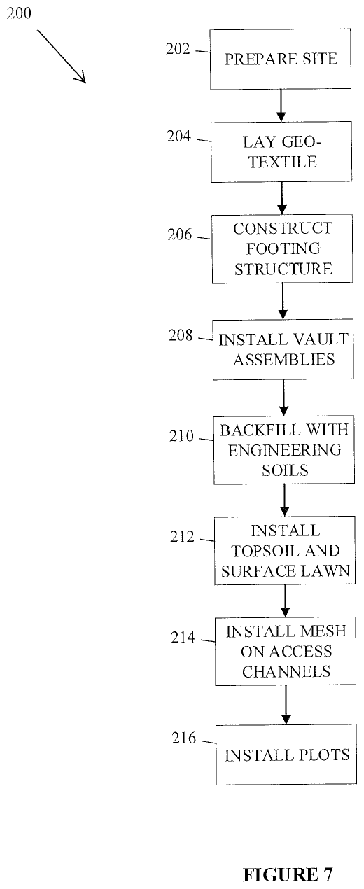

A flowchart is shown in FIG. 7 showing a method for constructing the system 10. Firstly a site for the system 10 is selected and prepared 202 for system 10 installation. The site is preferably cleared to form a generally planar top surface which is suitable for mounting vault assemblies 20. The planar top surface may be the natural ground surface stripped of organic material and/or top soil, and is referred to herein as the natural ground level 90. Geotextiles 204 may be laid on the natural ground level 90 to form a base for rafts 120 to be constructed 206. The rafts 120 are used as a footing structure for the vault assemblies 20 and are installed over sections of the geotextile. Once the footing structures or rafts 120 have been constructed, the vaults 100 can be installed onto said structures 208. A plurality of vaults 100 installed may be referred to as a vault assembly 20.

Once all vaults 100 have been installed, the system 10 can be backfilled with engineering soil 50. The engineering soil 50 may be granular, coarse or fine material, such as sand, gravel, granular concrete, construction aggregate or blue metal, which allows for relatively consistent drainage of liquids entering into the system, such as from rain or irrigation systems. Preferably, the engineering soils have a predetermined particle size or distribution which may be used to form gaps or voids between particles of the engineering soil 50. Preferably, the engineering soil is at least one of; a homogenous material, a uniform material or uniform mixture of materials which has at least one desired engineering property. It is preferred that the engineering soil is substantially free from natural soils from the site, unless said soils meet the engineering soil propeliies. For example, a system 10 constructed in sand dunes. The desired engineering propeliy may be a desired drainage, a desired compaction, a desired static effect or any other desired propeliy. However, any desired engineering soil 50 backfill may be provided to the system to assist with directing the flow of fluids. After backfilling with engineering soil is complete, topsoil sections can be installed, which are generally above the buried vault assemblies 20 (see FIG. 6, for example). Adjacent to the topsoil sections a paving or pathway 30 can be installed 214. The pathway 30 is preferably installed above an access channel, which can be excavated to form a trench 15. The trench 15 may then be used to access the vaults when needed. When a vault is occupied, at least one plot can be disposed on the topsoil section 216 indicating the occupant of a vault.

Referring to FIG. 8, there is shown an embodiment of a trench 15 what has been formed in the system 10. The paving of the pathway 30 has been partially removed to form the trench the access the vault 100. The removable wall 108 can be removed at the bottom of the trench 15 and an occupant can be placed within the vault and/or decomposed remains can be moved aside within the tomb, but preferably not removed from tomb and allow for another occupant to be placed within the vault. The cut batters of the trench 15 may be supported by any desired means, such as a retaining wall or sheet piles, to temporarily support a cut batter such that a person working at the bottom of a trench 15 is not accidentally buried if there is a collapse of the trench. In another embodiment, a degradable cement binder is injected into the engineering fill before excavation to provide a more stable trench 15.

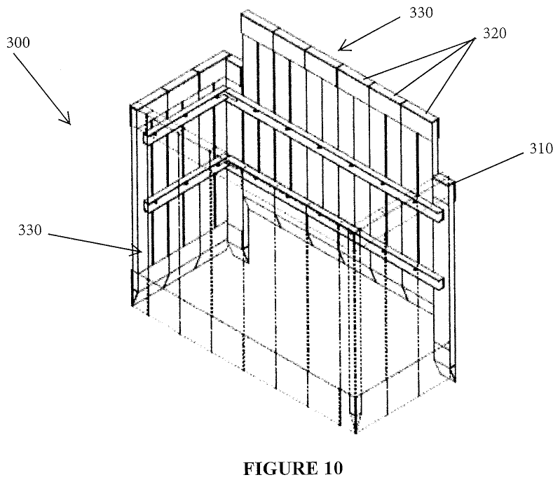

A bottom view of an embodiment of a vault 100 is illustrated in FIG. 9. As shown, the bottom of the vault is free of a floor. Optionally, the engineering soil can be backfilled such that a floor is constructed from the engineering soil and/or the footings 122. As such, a casket or wrapped body, or other material to decompose can be mounted onto sand or footings 122 or supports 128 within the receptacle. It is preferably that the vaults are formed without floors to increase the air flow into the vaults to assist with decomposition.

The system 10 of the present disclosure may allow for decomposition of a body in a period of between 5 to 12 years, depending on rainfall, moisture and humidity of the environment. Preferably, the engineering soils 50 installed in the system 10 allow for the moisture to be transported out of the system relatively quickly to oxygenate the system 10 to accelerate decomposition.

The walls 102 and ceiling 104 of the structure are preferably formed with sufficient concrete cover to ensure that internal reinforcing is covered during use and therefore concrete cancer is less likely to occur. Preferably, the concrete cover of the walls is between 5 mm to 100 mm depending on the volume of sand above the structure.

The volume of sand or engineering fill above the structure may be of a minimum depth such a requirement by the health authorities.

Preferably, the system improves the oxygen exposure to the casket which may assist with decomposition of a body with a casket. Further, the system may also provide for moisture removal to keep caskets more dry for longer periods of time. It will be appreciated that drainage systems for caskets may be used to assist with drying soils adjacent to the casket.

Preferably, geotextiles are laid at the surface to allow for a more stable structure and reduce movement of the rafts which may occur during settlement or with high volumes of fluids in the system 10. The geotextiles may be a woven or non-woven fabric which may assist in preventing the loss of sand or other engineered soil and prevent sand or engineered soil to mix with clay soil.

Backfilled soils may comprise granular materials which readily allow for moisture to be drained through from the system 10. Preferably, the backfill materials are sands or gravels which can be compacted or have minimal settlement issues after backfill.

Optionally, in-situ soils above the casket can be replaced with engineering soils which allows for improved drainage around the vaults 100. However, in one embodiment, only the trenches 15 to access vaults are replaced with engineering soils and the natural soils above the vaults 100 are retained in their natural position. This may reduce the need for removal of materials, and also reduces the overall environmental impact due to burial. In addition, having engineering soils within only trenches may assist with directing liquids from the system if the trenches comprise further drainage structures below the level of the raft 120. For example, drains may be installed below the raft 120 and be used to more efficiently direct liquids, such as water, from the system 10.

Optionally, other drainage structures may be used to reduce moisture content, such as wick drains. These drainage structures may require minimal maintenance and be effective over a period of decomposition. Preferably, any drainage structure is replaced when tombs are accessed. This may allow for more effective removal of moisture within the system.

After a known period of time has elapsed, a grave can be opened safely with the body having decomposed due to the system. For example, the period of time may be between 5 to 12 years, depending on experienced weather conditions of the system 10. The vault 100 may then be reused and the system can begin again. This allows for a reduction of land usage as vaults 100 can be used more than once in a relatively short period of time. Further, as the decomposition rate of bodies can be accelerated, the need for further land consumption can also be reduced.

In another embodiment, the system comprises a vault stacks which can block residents of the vaults 100 in a predetermined plan vertically in addition to horizontally. If vaults are stacked, each vault will be positioned on a respective support structure such that fluids can easily be removed from the vault stacks and more readily increase oxygen levels to increase a rate of decomposition.

It is preferred that the receptacles of the vaults 100 are free from, or substantially free from, engineering soil 50 when in use. Allowing a larger volume of oxygen near to a body will allow for a faster rate of decomposition and therefore the vault 100 can be reused more quickly.

It will be appreciated that accelerating the decomposition of bodies may allow for reuse of a vault 100 when the resident has decomposed such that one bones remain within the vault receptacle. In this way the vaults can be used more effectively and less space is wasted as further cemetery spaces are not required or vastly reduced.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A system for renewable interment and improved body decomposition, the system comprising;
a vault assembly comprising at least one reusable vault mounted on a raft; the at least one reusable vault comprising a respective removable access wall,
wherein the removable access wall is selectively removable from the vault to allow access for reuse;
wherein the raft comprises at least one footing structure adapted to underlie the at least one reusable vault such that the ground on which the footing structure rests is adapted to function as the floor of the reusable vault; and
a porous granular material adapted to at least partially bury the at least one footing structure and at least partially surround the at least one reusable vault to direct oxygen-carrying fluid through and out of the vault assembly such that the growth of decomposition bacteria is supportable within the at least one reusable vault.

2. The system as claimed in claim 1 wherein the fluid drains through the porous granular material towards the bottom of the vault.

3. A system as claimed in claim 1 wherein the system comprises a plurality of reusable vaults.

4. The system as claimed in claim 1, wherein the vaults of the vault assembly comprise two side walls, a rear wall and a ceiling which are integrally formed and define a vault receptacle, wherein the vaults are constructed without a floor.

5. The system as claimed in claim 1, wherein the vault and raft are wholly buried by the porous granular material.

6. The system as claimed in claim 5, wherein the porous granular material is an engineering soil fill.

7. The system as claimed in claim 1, wherein the removable access wall of the vault comprises a plurality of panels and at least one access means.

8. The system as claimed in claim 1, wherein the footing structures are retained in a predetermined spacing by a spacer, further comprising retaining flanges in which the footing structures are mounted.

9. The system as claimed in claim 4, wherein the ceiling is tapered towards the rear wall to direct liquids away from the removable wall.

10. The system as claimed in claim 1, wherein a lip is provided in the vault to mount the removable access wall.

11. The system as claimed in claim 1, wherein the raft elevates the vault above a natural ground level.

12. The system as claimed in claim 1 wherein the oxygen-carrying fluid is water.

13. A system for renewable interment and improved body decomposition, the system comprising;
a vault assembly comprising at least one reusable vault mounted on a raft,
the at least one reusable vault comprising two side walls and a ceiling defining a receptacle;
the reusable vault further comprising at least one removable access wall to allow access to the receptacle for reuse;
wherein the walls are supported on at least one footing of the raft, and wherein the at least one footing is retained in a predetermined position by at least one spacer; and wherein a porous granular material is adapted to at least partially bury the at least one footing structure and at least partially surround the at least one reusable vault to direct oxygen-carrying fluid through and out of the vault assembly such that the growth of decomposition bacteria is supportable within the reusable vault.

14. The system as claimed in claim 13 comprising a plurality of reusable vaults.

15. The system as claimed in claim 13, wherein the spacers are perpendicular to the footings; and wherein the vault further comprises a rear wall which opposes the removable access wall.

16. The system as claimed in claim 13 wherein the removable wall comprises a plurality of panels.

17. A method for constructing a renewable interment internment and improved body decomposition system, the method comprising:
mounting a footing structure on a ground surface;
fixing at least one reusable vault to the footing structure to form a vault assembly in which a bottom of the reusable vaults is exposed to the raft;
burying at least a portion of the vault assembly with a porous granulated engineering soil so as to at least at least partially bury the at least one footing structure and at least partially surround the at least one reusable vault to direct oxygen-carrying fluid through and out of the vault assembly such that the growth of decomposition bacteria is supportable within the reusable vault; and installing a topsoil section over the engineering soil relatively above the vault assembly.

18. The method as claimed in claim 17, wherein the footing is mounted on a geotextile on the ground surface to minimize loss or integration of the porous granulated engineering soil into natural ground.

19. The method as claimed in claim 17, wherein a plurality of vault assemblies are constructed in parallel in which respective topsoil sections are installed relatively above respective vault assemblies of the plurality of vault assemblies, and at least one pathways is constructed between the topsoil sections.

20. The method as claimed in claim 19, wherein the pathways are removable such that a trench can be excavated to install a resident into the vault assemblies.
